(19) United States
(12) Patent Application Publication
(10) Pub. No.: US 2025/0187161 A1
(43) Pub. Date: Jun. 12, 2025

(54) Fastener Driving Device

(71) Applicant: TOGROUP TECHNOLOGY (SUZHOU) CO., LTD, SUZHOU (CN)

(72) Inventor: XIAO HUA DENG, Suzhou (CN)

(21) Appl. No.: 18/611,756

(22) Filed: Mar. 21, 2024

(30) Foreign Application Priority Data
Dec. 6, 2023 (CN) 2023116635600

(51) Int. Cl. B25C 1/06

(52) U.S. Cl. CPC B25C 1/06

(57) ABSTRACT

A fastener driving device includes an energy storage unit, an impact unit, a transmitting unit and a driving unit. The impact unit moves in a first direction to drive a fastener into a workpiece. The transmitting unit connects the energy storage unit with the impact unit. The driving unit is capable of cooperating with the impact unit. During a transition of the energy storage unit from an energy release state to an energy storage state, the driving unit drives the impact unit to move in a second direction, the impact unit drives the energy storage unit to store energy through the transmitting unit; during a transition of the energy storage unit from the energy storage state to the energy release state, the energy storage unit releases energy along the second direction to drive the transmitting unit, the transmitting unit drives the impact unit to move along the first direction.

### FIELD OF THE INVENTION

The application relates to the field of power tools, particularly to a fastener driving device.

### BACKGROUND OF THE INVENTION

Generally, a fastener driving device includes an energy storage unit, the energy storage unit includes a spring. The fastener driving device needs to compress the spring to store energy and then rapidly release the spring to achieve external work, that is, the fastener driving device needs to rapidly release the spring to achieve the function of driving a fastener into a workpiece. Specifically, the existing fastener driving device stores energy by compressing the spring in a first direction and then rapidly release the spring in a second direction to drive the fastener into the workpiece, the first direction is opposite to the second direction. The fastener driving device that utilize the spring to store or release energy usually have the drawback of significant recoil, that is, the recoil momentum acting on the body of the fastener driving device, especially the handle part, is large, resulting in a greater recoil force felt by the user.

Therefore, it is necessary to provide a new fastener driving device.

### SUMMARY OF THE INVENTION

The application provides a fastener driving device with stable and smooth operation. Specifically, the application offers a fastener driving device, including:
an energy storage unit, having an energy storage state and an energy release state;
an impact unit, moving along a first direction to drive a fastener into a workpiece;
a transmitting unit, connecting the energy storage unit with the impact unit;
a driving unit, capable of cooperating with the impact unit; wherein,
during a transition of the energy storage unit from the energy release state to the energy storage state, the driving unit drives the impact unit to move in a second direction different from the first direction, and the impact unit drives the energy storage unit to store energy through the transmitting unit; during a transition of the energy storage unit from the energy storage state to the energy release state, the energy storage unit releases energy along the second direction to drive the transmitting unit, and the transmitting unit drives the impact unit to move along the first direction.

In the application, the fastener driving device includes an energy storage unit, a transmitting unit, an impact unit and a driving unit. The energy storage unit releases energy in the second direction to drive the transmitting unit, the transmitting unit drives the impact unit to move in the first direction, the first direction is different from the second direction. The impact unit moves in the first direction to drive the fastener into the workpiece. The direction of energy releasing (i.e., the second direction) is different from the direction of fastener driving (i.e., the first direction), utilizing the principle of momentum balance to significantly reduce the recoil of the fastener driving device, thus improving user experience. Additionally, during the transition of the energy storage unit from the energy release state to the energy storage state, the driving unit drives the impact unit to move in the second direction, and the impact unit drives the energy storage unit to store energy through the transmitting unit. When the energy storage unit is in the energy storage state, at least part of the impact unit is located in the energy storage unit, eliminating the need for the driving unit to be offset, this design can significantly reduce the partial loading of the driving unit and also reduce the length of the overall device.

### BRIEF DESCRIPTION OF THE DRAWINGS

FIG. 1 is a schematic diagram of the structure of the fastener driving device of the application;

FIG. 2 is a schematic diagram of the structure of the driving unit shown in FIG. 1;

FIG. 3 is a cross-sectional view of the driving unit shown in FIG. 2 along the line C-C;

FIG. 4 is a schematic diagram of the structure of the first engaging mechanism and the second engaging mechanism shown in FIG. 1;

FIG. 5 is a schematic diagram of part of the structure of the fastener driving device shown in FIG. 1;

FIG. 6 is a cross-sectional view of the part of the structure shown in FIG. 5 along the line C-C;

FIG. 7 is a cross-sectional view of the part of the structure shown in FIG. 6 along the line D-D;

FIG. 8 is a schematic diagram of a plurality of states in the working cycle of the fastener driving device of the application.

### DETAILED DESCRIPTION OF THE EMBODIMENTS

Herein detailed descriptions of exemplary embodiments are provided, which are represented in the attached drawings. When referring to the drawings, unless otherwise indicated, the same numbers in different FIGS. represent the same or similar elements. The embodiments described in the following exemplary embodiments do not represent all embodiments consistent with the application.

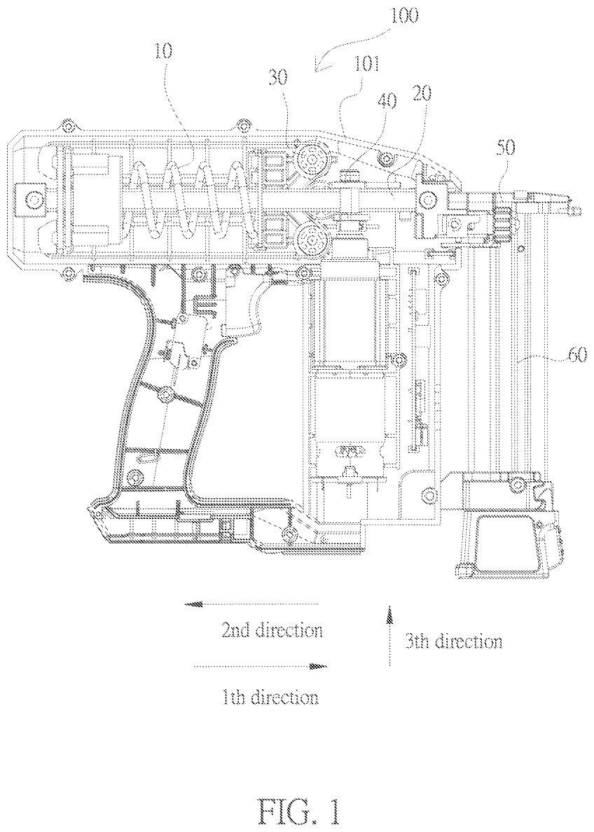

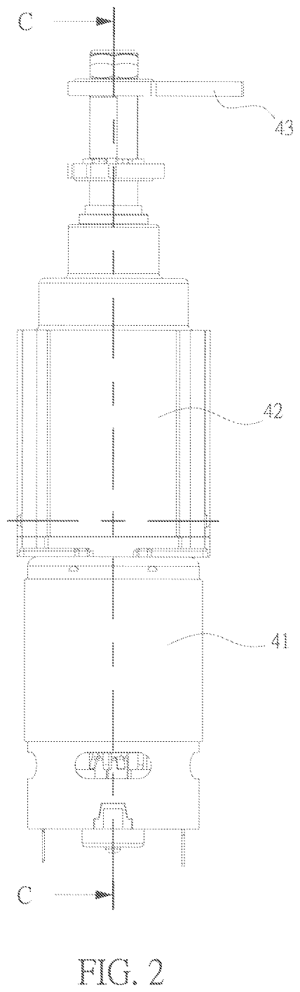

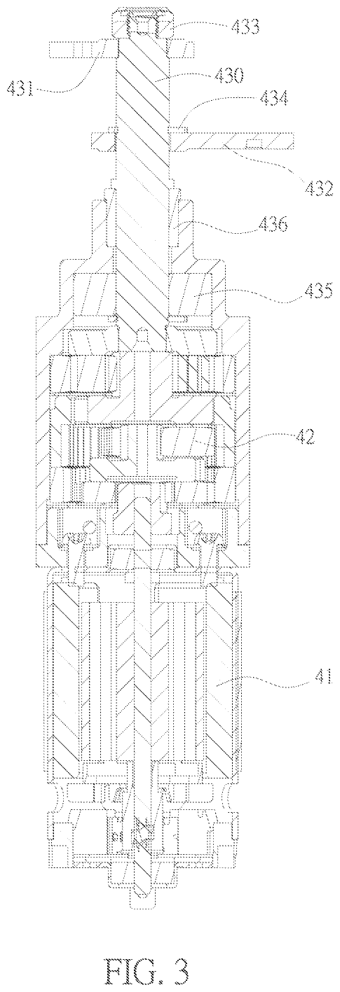

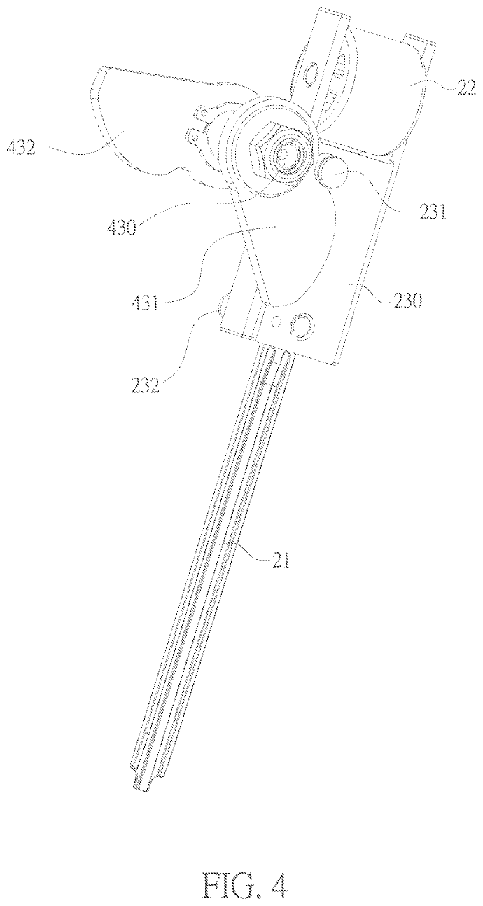

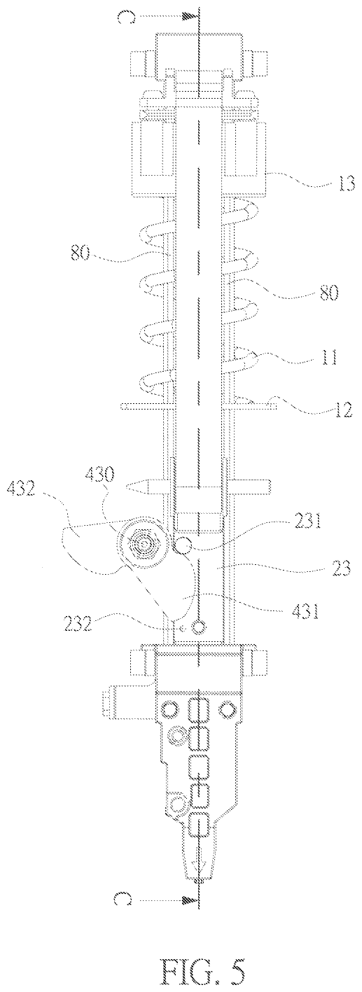

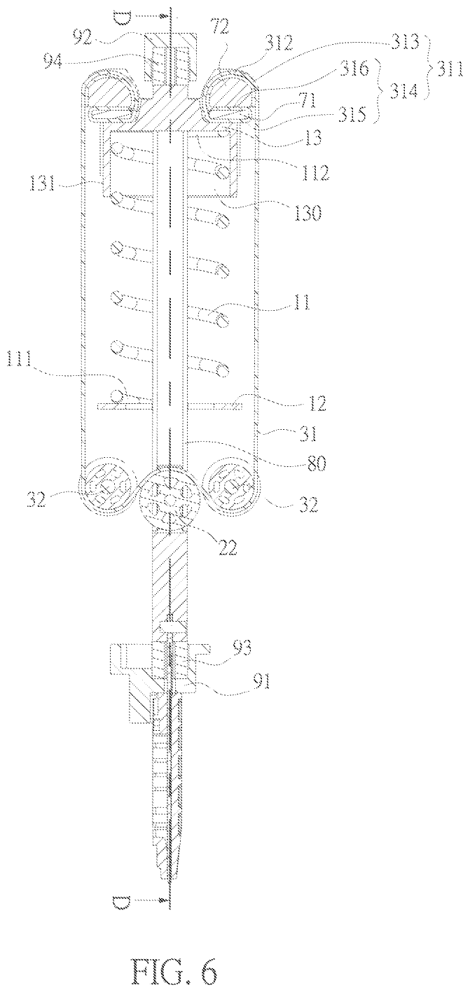

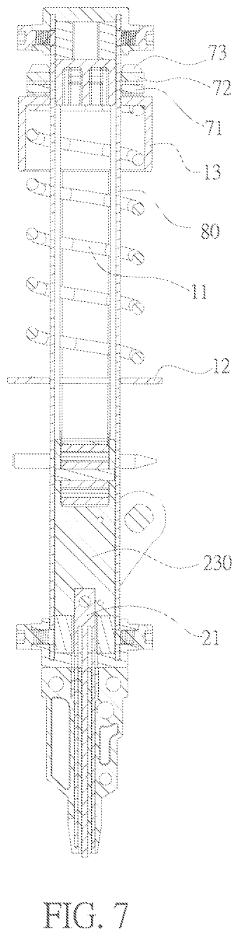

Please refer to FIGS. 1 to 8, the application provides a fastener driving device 100, which includes a housing 101, an energy storage unit 10, an impact unit 20, a transmitting unit 30 and a driving unit 40. The energy storage unit 10, the impact unit 20, the transmitting unit 30 and the driving unit 40 are installed in the housing 101. The transmitting unit 30 connects the energy storage unit 10 with the impact unit 20. The fastener driving device 100 also includes a fastener guide plate 50 and a fastener storage clip 60, the fastener storage clip 60 is connected to the fastener guide plate 50. The fastener storage clip 60 contains fasteners (not shown in the figure), and the fasteners can be transported from the fastener storage clip 60 to the fastener guide plate 50, the fastener guide plate 50 guides the fasteners, the fasteners are driven into the workpiece by the impact unit 20. In the application, the fasteners are nails, the fastener guide plate 50 is a nail guide plate, and the fastener storage clip 60 is a nail storage clip.

In the application, the impact unit 20 moves along a first direction to drive fasteners into the workpiece. The energy storage unit 10 has an energy storage state and an energy release state. During the transition of the energy storage unit 10 from the energy release state to the energy storage state, the driving unit 40 is cooperated with the impact unit 20, the driving unit 40 drives the impact unit 20 to move in a second direction which is different from the first direction, and the impact unit 20 drives the energy storage unit 10 to store energy through the transmitting unit 30. Specifically, the impact unit 20 drives the transmitting unit 30, the transmitting unit 30 drives the energy storage unit 10 to store energy. During the transition of the energy storage unit 10 from the energy storage state to the energy release state, the driving unit 40 is not cooperated with the impact unit 20, the energy storage unit 10 releases energy along the second direction to drive the transmitting unit 30, the transmitting unit 30 drives the impact unit 20 to move along the first direction to drive the fasteners into the workpiece. In the application, the second direction is opposite to the first direction. The energy storage state is the state in which the energy storage unit 10 has finished storing energy, and the energy release state is the state in which the energy storage unit 10 has finished releasing energy. When the energy storage unit 10 is in the energy storage state, at least a part of the impact unit 20 is disposed in the energy storage unit 10. This design reduces the overall length of the fastener driving device 100.

In the application, the energy storage unit 10 releases energy in the second direction, the impact unit 20 drive fasteners into the workpiece in the first direction through the energy which is transferred by the transmitting unit 30. The direction of energy releasing (i.e., the second direction) is opposite to the direction of fastener driving (i.e., the first direction), utilizing the principle of momentum balance to significantly reduce the recoil of the body of the fastener driving device, especially the handle part, thus improving user experience.

The energy storage unit 10 serves as a medium that can store energy through displacement, such as air springs, mechanical springs, rubber components and vacuum, etc. In the application, the energy storage unit 10 includes a spring 11, a baffle 12 and an end cap 13. The spring 11 is located between the end cap 13 and the baffle 12, the baffle 12 is fixedly installed in the housing 101. When the energy storage unit 10 is in the energy release state, the baffle 12 is positioned between the spring 11 and the impact unit 20; when the energy storage unit 10 is in the energy storage state, at least part of the impact unit 20 is located in the spring 11. The spring 11 includes a fixed end 111 and a movable end 112, the movable end 112 is movable relative to the fixed end 111. The fixed end 111 of the spring 11 is fixed to the baffle 12, and the movable end 112 of the spring 11 is accommodated in a receiving space 130 formed by the end cap 13. Specifically, the end cap 13 includes a cylindrical tube portion 131, which has the aforementioned receiving space 130. A part of the spring 11 where the movable end 112 is located is accommodated in this receiving space 130. The end cap 13 guides the movement of the movable end 112 of the spring 11 and moves together with the movable end 112 of the spring 11. The movable end 112 of the spring 11 moves in the second direction to release energy, and the movable end 112 of the spring 11 moves in the first direction to store energy; specifically, during the transition of the energy storage unit 10 from the energy storage state to the energy release state, the movable end 112 of the spring 11 moves in the second direction to release energy. The spring 11 drives the end cap 13 to move in the second direction, the end cap 13 drives the transmitting unit 30, and the transmitting unit 30 drives the impact unit 20 to move in the first direction; during the transition of the energy storage unit 10 from the energy release state to the energy storage state, the driving unit 40 drives the impact unit 20 to move in the second direction, the impact unit 20 drives the transmitting unit 30, the transmitting unit 30 drives the end cap 13 to move in the first direction, and the end cap 13 drives the movable end 112 of the spring 11 to move in the first direction to store energy. The movable end 112 of the spring 11 is linked with the impact unit 20 through the transmitting unit 30, thereby making the moving direction of the movable end 112 of the spring 11 different from the moving direction of the impact unit 20.

The driving unit 40 includes a motor 41, a gear transmission mechanism 42 and a first engaging mechanism 43, the gear transmission mechanism 42 is connected between the motor 41 and the first engaging mechanism 43, the first engaging mechanism 43 includes a rotatable output shaft 430, a first cam 431 and a second cam 432, both the first cam 431 and the second cam 432 are mounted on the output shaft 430 and rotate with the output shaft 430, the first cam 431 and the second cam 432 are misaligned along an axial direction of the output shaft 430. The first engaging mechanism 43 also includes a nut 433 and a circlip 434, the first cam 431 is limited by the nut 433 on the output shaft 430, the second cam 432 is limited by the circlip 434 on the output shaft 430. The motor 41 provides torque and speed, the torque and speed are output through the gear transmission mechanism 42, the gear transmission mechanism 42 is used to reduce speed while increasing torque. The gear transmission mechanism 42 includes one stage of planetary gear or a plurality of stages of planetary gear; in this embodiment, the gear transmission mechanism 42 includes three stages of planetary gear. The torque and speed output by the motor 41 is transmitted to an output shaft 430 of the first engaging mechanism 43 through the gear transmission mechanism 42. The output shaft 430 is supported by at least one bearing 435 and at least one shaft sleeve 436; the bearing 435, the shaft sleeve 436 and the gear transmission mechanism 42 are placed in the gearbox. It should be noted that the gear transmission mechanism 42 is not necessary, when the torque output by the motor 41 is large enough, the shaft of the motor 41 can be directly used as the output shaft 430 of the first engaging mechanism 43.

The impact unit 20 includes a second engaging mechanism 23, an impactor 21 and a driving wheel 22, the impactor 21 and the driving wheel 22 are connected to the second engaging mechanism 23. The second engaging mechanism 23 includes a base 230, a first engaging portion 231 and a second engaging portion 232, the first engaging portion 231 and the second engaging portion 232 are set on the base 230. The base 230 is connected to the impactor 21 via a pin so that the base 230 and the impactor 21 can move together. The impactor 21 is used to drive fasteners into the workpiece. The driving wheel 22 is mounted on the base 230 via a pin, the driving wheel 22 can be rotated around the pin. The driving wheel 22 is connected to the transmitting unit 30, thereby driving the energy storage unit 10 to store energy. The base 230 can also be designed to be directly connected to the transmitting unit 30; therefore, for the overall function of the device, the driving wheel 22 is not essential. In the application, the driving wheel 22 is introduced to reduce friction caused by force imbalance. In the application, the first engaging portion 231 is a first stuck shaft, and the second engaging portion 232 is a second stuck shaft. The first cam 431 is engaged with the first stuck shaft 231, and the second cam 432 is engaged with the second stuck shaft 232.

As the first cam 431 and the second cam 432 are misaligned along the axial direction of the output shaft 430, the first cam 431 can only be engaged with the first stuck shaft 231, and the second cam 432 can only be engaged with the second stuck shaft 232, without interfering with each other. A first shaft sleeve is installed on the first stuck shaft 231, and a second shaft sleeve is installed on the second stuck shaft 232, which can reduce friction during engagement.

The transmitting unit 30 includes a transmitting belt 31 and two fixed pulleys 32, the two fixed pulleys 32 are installed on the housing 101, and the transmitting belt 31 is mounted on the two fixed pulleys 32. The transmitting belt 31 is connected between the driving wheel 22 of the impact unit 20 and the end cap 13 of the energy storage unit 10. In the application, the fixed pulley 32 is a roller, which can rotate around the roller shaft, and the roller shaft is installed in the housing 101, therefore, the roller plays a role as a fixed pulley. In the application, the transmitting belt 31 is a fiber braided belt; it is noted that in other embodiments, the transmitting belt 31 can also be a leather belt, steel wire rope, or other fiber braided rope. The transmitting unit 30 is set so that the moving direction of the movable end 112 of the spring 11 is opposite to the moving direction of the impact unit 20.

The method of connecting the transmitting belt 31 to the end cap 13 can vary depending on the type of transmitting belt 31 which is adopted. In the application, the transmitting belt 31 is a braided belt, which includes a middle portion 311 and two end portions 312. The fastener driving device 100 also includes a first fixing plate 71, a second fixing plate 72 and a fixing element 73. The transmitting belt 31 includes a middle portion 311 and two end portions 312 located on two sides of the middle portion 311, the middle portion 311 includes a body portion 313 and two connecting portions 314 located on two sides of the body portion 313, the connecting portion 314 is connected between the body portion 313 and the end portion 312, the connecting portion 314 includes a first connecting portion 315 and a second connecting portion 316 which are adjacent to each other, the first connecting portion 315 is clamped between the end cap 13 and the first fixing plate 71, the second connecting portion 316 is clamped between the first fixing plate 71 and the second fixing plate 72, the end portion 312 is clamped between the body portion 313 and the second fixing plate 72, the body portion 313 is connected to the driving wheel 22 of the impact unit 20 after passing over the fixed pulleys 32. The fixing element 73 fixes the end cap 13, the first fixing plate 71 and the second fixing plate 72 together, in the application, the fixing element 73 is a screw.

Specifically, a maze-like fixed mode is adopted between the transmitting belt 31 and the end cap 13, that is, the transmitting belt 31 passes through the gap between the first fixing plate 71 and the end cap 13, then passes through the gap between the second fixing plate 72 and the first fixing plate 71, and then the end portion 312 of the transmitting belt 31 is placed between the second fixing plate 72 and the body portion 313 of the transmitting belt 31, finally, the first fixing plate 71 and the second fixing plate 72 is fixed to the end cap 13 by the fixing element 73. This maze-like fixed mode increases the contact area between the transmitting belt 31 and the fixing components (i.e., the first fixing plate 71 and the second fixing plate 72). Additionally, the end portion 312 of the transmitting belt 31 is placed between the second fixing plate 72 and the body portion 313 of the transmitting belt 31, when the transmitting belt 31 is loosed, the end portion 312 of the transmitting belt 31 moves in the second direction, and the body portion 313 of the transmitting belt 31 moves in the first direction, the moving direction of the body portion 313 of the transmitting belt 31 is opposite to the moving direction of the end portion 312 of the transmitting belt 31, when the transmitting belt 31 is tensioned, a self-locking effect can be achieved between the body portion 313 and the end portion 312. Therefore, this maze-like fixed mode significantly increases the force required to loosen the transmitting belt 31. It should be noted that, for one transmitting belt 31, it could also be that the end portion 312 of the transmitting belt 31 is connected to the impact unit 20, and the middle portion 311 of the transmitting belt 31 is connected to the end cap 13 after passing over the fixed pulleys 32. In other embodiments, if two transmitting belts 31 are adopted, two end portions 312 of the transmitting belt 31 are respectively connected to the end cap 13 and the impact unit 20; or, if an annular transmitting belt 31 is adopted, it is only necessary to hang the annular transmitting belt 31 on the end cap 13 and connect the annular transmitting belt 31 with the impact unit 20 after passing over the fixed pulleys 32.

The impact unit 20 and the spring 11 are arranged along the stretching and contracting direction of the spring 11, two fixed pulleys 32 are positioned on two side of the spring 11 along a third direction. The third direction is perpendicular to the stretching and contracting direction of the spring 11. This design ensures that when the impact unit 20 moves in the second direction, the movable end 112 of the spring 11 of the energy storage unit 10 is compressed in the first direction. Two gaskets 33 are placed on both sides of the fixed pulley 32 to restrict the transmitting belt 31 and prevent the transmitting belt 31 from offsetting along the axial direction of the fixed pulley 32.

The first engaging mechanism 43 is periodically engaged with or disengaged from the second engaging mechanism 23. When the first engaging mechanism 43 is engaged with the second engaging mechanism 23, the driving unit 40 drives the impact unit 20 to move in the second direction. The impact unit 20 drives the transmitting unit 30, the transmitting unit 30 drives the end cap 13 to move in the first direction, and the end cap 13 drives the movable end 112 of the spring 11 to move in the first direction to store energy. When the first engaging mechanism 43 is disengaged from the second engaging mechanism 23, the movable end 112 of the spring 11 moves in the second direction, the movable end 112 of the spring 11 drives the end cap 13 to move in the second direction, the end cap 13 drives the transmitting unit 30, and the transmitting unit 30 drives the impact unit 20 to move in the first direction to drive the fastener into the workpiece. Specifically, the first cam 431 is periodically engaged with or disengaged from the first stuck shaft 231 during the rotation of the first cam 431 with the output shaft 430, and the second cam 432 is periodically engaged with or disengaged from the second stuck shaft 232 during the rotation of the second cam 432 with the output shaft 430. The first cam 431 is engaged with the first stuck shaft 231 to allow the driving unit 40 to drive the impact unit 20 to move in the second direction, and the second cam 432 is engaged with the second stuck shaft 232 to allow the driving unit 40 to drive the impact unit 20 to move in the second direction.

When the output shaft 430 rotates, the first cam 431 is firstly engaged with the first stuck shaft 231. After the driving unit 40 drives the impact unit 20 to move a certain distance, the second cam 432 is engaged with the second stuck shaft 232, then the first cam 431 is disengaged from the first stuck shaft 231. Due to the engagement of the second cam 432 with the second stuck shaft 232, the driving unit 40 continues to drive the impact unit 20 to move until the second cam 432 is disengaged from the second stuck shaft 232. Thereafter, the impact unit 20 completes the driving action of the fastener under the action of the energy released by the energy storage unit 10. The first cam 431 and the second cam 432 are designed with specific shapes, allowing the rotational motion of the first cam 431 and the second cam 432 to be transformed into the linear motion of the impact unit 20. During a rotational period of the output shaft 430, a rotational angle of the first cam 431 is less than 180° when the first cam 431 is maintaining an engagement with the first stuck shaft 231, and a rotational angle of the second cam 432 is less than 180° when the second cam 432 is maintaining an engagement with the second stuck shaft 232. Therefore, after the second cam 432 is disengaged from the second stuck shaft 232, and after the impact unit 20 completes the driving action of the fastener, the first cam 431 will be engaged with the first stuck shaft 231 again after a period of time.

The fastener driving device 100 also includes two parallel guiding rails 80, the guiding rails 80 are installed in the housing 101. The guiding rail 80 is in a long strip shape, the impact unit 20 is positioned between the two guiding rails 80, the impact unit 20 moves along the two guiding rails 80 to maintain a linear motion. The two guiding rails 80 pass through the energy storage unit 10, specifically, the two guiding rails 80 pass through the end cap 13, the spring 11 and the baffle 12 along the stretching and contracting direction of the spring 11. During the transition of the energy storage unit 10 from the energy release state to the energy storage state, the driving unit 40 drives the impact unit 20 to move in the second direction; when the energy storage unit 10 is in the energy storage state, at least part of the impact unit 20 is located in the spring 11. This design reduces the overall length of the fastener driving device 100.

The fastener driving device 100 also includes a first base 91 connected to one end of the two guiding rails 80 and a second base 92 connected to the other end of the two guiding rails 80. The first base 91 is connected to one end of the two guiding rails 80 by at least one screw, and the second base 92 is connected to the other end of the two guiding rails 80 by at least one screw, both the first base 91 and the second base 92 are installed in the housing 101. The fastener driving device 100 also includes a first buffering member 93 mounted on the first base 91 and a second buffering member 94 mounted on the second base 92. The fastener guide plate 50 is connected to the first base 91. When the energy storage unit 10 releases energy, the movable end 112 of the spring 11 drives the end cap 13 to move in the second direction. The end cap 13 drives the transmitting unit 30, the transmitting unit 30 drives the impact unit 20 to move in the first direction, and the impact unit 20 drives the fasteners from the fastener guide plate 50 into the workpiece after passing through the first base 91 and the first buffering member 93. After the impact unit 20 moves in the first direction to drive the fastener into the workpiece, the impact unit 20 strikes the first buffering member 93, and the end cap 13 strikes the second buffering member 94.

Due to the impact unit 20 and the spring 11 may still have residual energy after completing the driving action of the fastener, the impact unit 20 and the end cap 13 will respectively strike the first buffering member 93 and the second buffering member 94, the residual energy is absorbed by the first buffering member 93 and the second buffering member 94 to prevent damage to other parts. It should be noted that when the overall output energy of the device is relatively low, the second base 92 and the second buffering member 94 are not necessary, and the guiding rails 80 do not need to pass through the end cap 13, the residual energy can be absorbed by the transmitting unit 30 and the first buffering member 93.

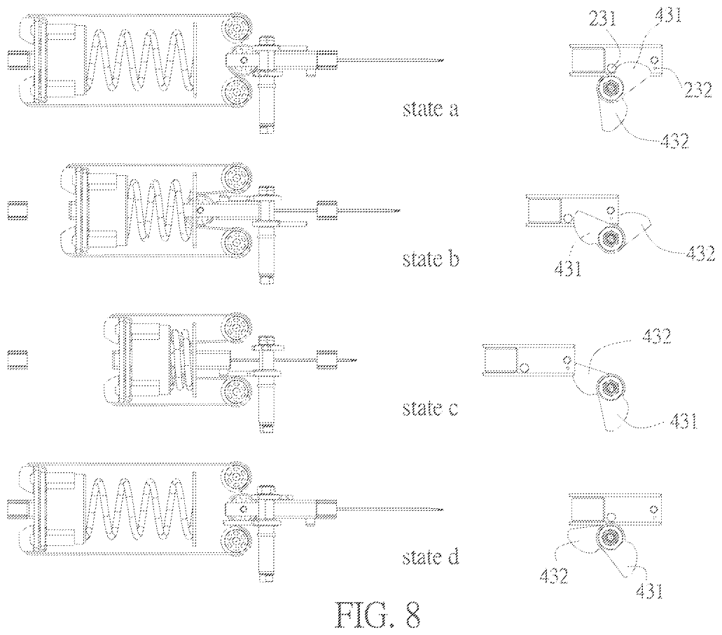

In conjunction with FIG. 8, the working principle of the fastener driving device 100 in the application is explained. The states a, b, c and d shown in FIG. 8 correspond to one working cycle.

The output shaft 430 rotates counterclockwise to the position shown in state a, the first cam 431 of the first engaging mechanism 43 of the driving unit 40 is about to be engaged with the first stuck shaft 231 of the second engaging mechanism 23 of the impact unit 20. As the output shaft 430 continues to rotate counterclockwise, the first cam 431 is engaged with the first stuck shaft 231, and the driving unit 40 drives the impact unit 20 to move in the second direction. The impact unit 20 applies force in the second direction to the transmitting belt 31, after the transmitting belt 31 passes over the fixed pulleys 32, the transmitting belt 31 applies force in the first direction to the movable end 112 of the spring 11 of the energy storage unit 10, the spring 11 is compressed in the first direction (the movable end 112 of the spring 11 moves in the first direction, the fixed end 111 of the spring 11 is connected to the baffle 12, the baffle 12 is fixed to the housing 101). As the output shaft 430 continues to rotate counterclockwise, the second cam 432 of the first engaging mechanism 43 of the driving unit 40 is engaged with the second stuck shaft 232 of the second engaging mechanism 23 of the impact unit 20, and the first cam 431 is disengaged from the first stuck shaft 231, as shown in state b. The driving unit 40 continues to drive the impact unit 20 to move in the second direction, and the impact unit 20 continues to apply force in the first direction to the movable end 112 of the spring 11 of the energy storage unit 10 through the transmitting unit 30, the spring 11 is compressed in the first direction. As the output shaft 430 continues to rotate counterclockwise, the second cam 432 is engaged with the second stuck shaft 232, the driving unit 40 drives the impact unit 20 to move to the top dead center, as shown in state c, simultaneously the impact unit 20 compresses the spring 11 in the first direction through the transmitting unit 30 to store energy. As the output shaft 430 continues to rotate counterclockwise, the second cam 432 is disengaged from the second stuck shaft 232, the spring 11 stretches in the second direction, the spring 11 applies force in the second direction to the transmitting belt 31, after the transmitting belt 31 passes over the fixed pulleys 32, the transmitting belt 31 applies force in the first direction to the impact unit 20, the transmitting belt 31 drives the impact unit 20 to move in the first direction to complete the driving action of the fastener. After completing the driving action of the fastener, the impact unit 20 strikes the first buffering member 93, and the end cap 13 connected to the movable end 112 of the spring 11 strikes the second buffering member 94. The first buffering member 93 absorbs the residual energy of the impact unit 20, and the second buffering member 94 absorbs the residual energy of the energy storage unit 10, as shown in state d. As the output shaft 430 continues to rotate counterclockwise, after the output shaft 430 is rotated by a certain angle, the first cam 431 of the first engaging mechanism 43 of the driving unit 40 can be engaged with the first stuck shaft 231 of the second engaging mechanism 23 of the impact unit 20 again, returning to the state a.

When the impact unit 20 moves in the second direction, the transmitting belt 31 is subjected to a force in the second direction, the force in the second direction is transformed into a force in the first direction through the fixed pulleys 32, the force in the first direction is applied to the movable end 112 of the spring 11, thereby compressing the movable end 112 of the spring 11 in the first direction. Similarly, after the first engaging mechanism 43 of the driving unit 40 is disengaged from the second engaging mechanism 23 of the impact unit 20, the movable end 112 of the spring 11 is released in the second direction. The transmitting belt 31 is subjected to a force in the second direction, and the force in the second direction is transformed into a force in the first direction through the fixed pulleys 32, the force in the first direction is applied to the impact unit 20, causing the impact unit 20 to move in the first direction to complete the driving action of the fastener. In other words, when the impact unit 20 performs the driving action of the fastener, the end cap 13 connected to the movable end 112 of the spring 11 moves in a direction opposite to the driving direction of the fastener. According to the principle of momentum balance, the recoil momentum acting on the body, especially the handle part, is greatly reduced, and the recoil force felt by the user is also significantly decreased.

The embodiments described above are merely preferred embodiments of the application and are not intended to limit the scope of the application in any form. Although the application has been disclosed above in preferred embodiments, they are not intended to limit the application. Any person skilled in the art can make slight changes or modifications as equivalent embodiments without departing from the scope of the technical solutions of the application, and any simple modification, equivalent changes, and modifications made to the above embodiments based on the technical essence of the application still fall within the scope of the technical solutions of the application.

I claim:

1. A fastener driving device, comprising:
an energy storage unit, having an energy storage state and an energy release state;
an impact unit, moving along a first direction to drive a fastener into a workpiece;
a transmitting unit, connecting the energy storage unit with the impact unit;
a driving unit, capable of cooperating with the impact unit; wherein,
during a transition of the energy storage unit from the energy release state to the energy storage state, the driving unit drives the impact unit to move in a second direction different from the first direction, and the impact unit drives the energy storage unit to store energy through the transmitting unit;
during a transition of the energy storage unit from the energy storage state to the energy release state, the energy storage unit releases energy along the second direction to drive the transmitting unit, and the transmitting unit drives the impact unit to move along the first direction.

2. The fastener driving device according to claim 1, wherein the first direction is opposite to the second direction.

3. The fastener driving device according to claim 1, wherein when the energy storage unit is in the energy storage state, at least part of the impact unit is disposed in the energy storage unit.

4. The fastener driving device according to claim 1, wherein
during the transition of the energy storage unit from the energy release state to the energy storage state, the driving unit is cooperated with the impact unit, and the driving unit drives the impact unit to move in the second direction different from the first direction;
during the transition of the energy storage unit from the energy storage state to the energy release state, the driving unit is not cooperated with the impact unit, and the energy storage unit releases energy along the second direction to drive the transmitting unit, the transmitting unit drives the impact unit to move along the first direction.

5. The fastener driving device according to claim 1, wherein the transmitting unit comprises a transmitting belt, the transmitting belt is connected between the energy storage unit and the impact unit.

6. The fastener driving device according to claim 5, wherein
the transmitting unit further comprises at least one fixed pulley, the transmitting belt is mounted on the at least one fixed pulley,
the energy storage unit comprises a spring, the spring comprises a fixed end and a movable end, the movable end is movable relative to the fixed end, and the movable end is associated with the impact unit through the transmitting unit, a moving direction of the movable end is different from a moving direction of the impact unit.

7. The fastener driving device according to claim 1, wherein the energy storage unit comprises a spring, the spring comprises a fixed end and a movable end, the movable end is movable relative to the fixed end, the movable end moves along the second direction to make the energy storage unit release energy, and the movable end moves along the first direction to make the energy storage unit store energy.

8. The fastener driving device according to claim 7, wherein the energy storage unit further comprises a baffle and an end cap, the fixed end is fixed to the baffle, the movable end is accommodated in a receiving space formed by the end cap, and the end cap moves together with the movable end.

9. The fastener driving device according to claim 8, wherein the transmitting unit comprises a transmitting belt, the transmitting belt is connected between the end cap and the impact unit.

10. The fastener driving device according to claim 9, wherein
the fastener driving device further comprises a first fixing plate, a second fixing plate and a fixing element,
the transmitting belt comprises a middle portion and two end portions located on both sides of the middle portion, the middle portion comprises a body portion and two connecting portions located on both sides of the body portion, the connecting portion is connected between the body portion and the end portion,
the connecting portion comprises a first connecting portion and a second connecting portion adjacent to each other, the first connecting portion is clamped between the end cap and the first fixing plate, the second connecting portion is clamped between the first fixing plate and the second fixing plate, the end portion is clamped between the body portion and the second fixing plate, and the fixing element fixes the end cap, the first fixing plate and the second fixing plate together.

11. The fastener driving device according to claim 1, wherein
the driving unit comprises a first engaging mechanism, the impact unit comprises a second engaging mechanism, the first engaging mechanism is periodically engaged with or disengaged from the second engaging mechanism,
when the first engaging mechanism is engaged with the second engaging mechanism, the driving unit drives the impact unit to move along the second direction,
when the first engaging mechanism is disengaged from the second engaging mechanism, the energy storage unit releases energy along the second direction to drive the transmitting unit, the transmitting unit drives the impact unit to move along the first direction.

12. The fastener driving device according to claim 11, wherein
the first engaging mechanism comprises an output shaft, a first cam and a second cam, both the first cam and the second cam are mounted on the output shaft and rotate with the output shaft, the first cam and the second cam are misaligned along an axial direction of the output shaft,
the second engaging mechanism comprises a first engaging portion and a second engaging portion,
the first cam is periodically engaged with or disengaged from the first engaging portion during a rotation of the first cam with the output shaft,
the second cam is periodically engaged with or disengaged from the second engaging portion during a rotation of the second cam with the output shaft.

13. The fastener driving device according to claim 12, wherein
the first cam is engaged with the first engaging portion, so that the driving unit drives the impact unit to move along the second direction,
the second cam is engaged with the second engaging portion, so that the driving unit drives the impact unit to move along the second direction;
during a rotational period of the output shaft, a rotational angle of the first cam is less than 180° when the first cam is maintaining an engagement with the first engaging portion, a rotational angle of the second cam is less than 180° when the second cam is maintaining an engagement with the second engaging portion.

14. The fastener driving device according to claim 11, wherein the impact unit further comprises an impactor and a driving wheel, the impactor and the driving wheel are connected to the second engaging mechanism, the impactor is used to driving the fastener into the workpiece, the driving wheel is mounted to the second engaging mechanism via a pin, and the driving wheel is capable of rotating around the pin.

15. The fastener driving device according to claim 14, wherein the transmitting unit comprises a transmitting belt, the transmitting belt is connected between the energy storage unit and the driving wheel.

16. The fastener driving device according to claim 1, wherein the fastener driving device further comprises at least one guiding rail, the impact unit moves along the at least one guiding rail;
the fastener driving device further comprises a first base connected to the at least one guiding rail and a first buffering member mounted on the first base, after the impact unit moves along the first direction to drive the fastener into the workpiece, the impact unit strikes the first buffering member.

17. The fastener driving device according to claim 8, wherein the fastener driving device further comprises at least one guiding rail, the at least one guiding rail passes through the spring and the end cap along a stretching and contracting direction of the spring;
the fastener driving device further comprises a second base connected to the at least one guiding rail and a second buffering member mounted on the second base, after the impact unit moves along the first direction to drive the fastener into the workpiece, the end cap strikes the second buffering member.
